(19) United States
(12) Patent Application Publication
(10) Pub. No.: US 2025/0273887 A1
(43) Pub. Date: Aug. 28, 2025

(54) CONNECTOR AND CONNECTOR ASSEMBLY INCLUDING SAME

(71) Applicant: Molex, LLC, Lisle, IL (US)

(72) Inventors: Hyong Jung Kang, Gyeonggi-do (KR); Byung Kyu Bae, Gyeonggi-do (KR); Jang Bum Jin, Gyeonggi-do (KR)

(21) Appl. No.: 19/063,889

(22) Filed: Feb. 26, 2025

(30) Foreign Application Priority Data
Feb. 26, 2024 (KR) 10-2024-0027432

(51) Int. Cl. H01R 12/77

(52) U.S. Cl. CPC H01R 12/778

(57) ABSTRACT

According to an embodiment of the present disclosure, a connector may include: a housing which has an opening formed in one end thereof to receive an FPC, and a plurality of slots formed in the other end thereof to receive terminals; and a plurality of terminals which are coupled to the plurality of slots, respectively, and the plurality of terminals may include a check portion extending and protruding in a direction away from a contact portion formed at one end thereof to contact the FPC.

### TECHNICAL FIELD

The present disclosure relates to a connector and a connector assembly including the same.

### BACKGROUND

Flexible printed circuits (FPCs) have circuits formed on flexible insulation films, and are widely used in various electronic devices due to their flexibility and lightweight characteristics, compared to rigid printed circuit boards which have circuits layered on thermosetting resin. A connector has one side opened to allow a connection end of an FPC to be inserted thereinto. For example, a connector has an insulation housing and a plurality of terminals, and the insulation housing has an opening formed on one end thereof to allow a connection end of an FPC to be inserted thereinto, and a plurality of slots formed on the other end thereof to be coupled with the plurality of terminals. Each of the terminals has a contact portion formed on one end thereof to contact the connection end of the FPC, and a fixing portion formed on the other end to contact a circuit board.

Typically, connectors may be checked for solder shorts, breaks, and component continuity measurements, etc. and it is determined whether the result of checking is a pass or a fail. One example of checking methods is to elastically bring a probe (or a check pin) (prove pin) into contact with an individual terminal of a connector. However, the individual terminals of the connectors are miniaturized as electronic devices are miniaturized, and hence, an end of a terminal may be bent and deformed by a force exerted to the terminals by the probe during a check, or a contact surface of a terminal which is in direct contact with the connection end of the FPC may be damaged or wear down due to the contact with the probe. The probe check does not influence electrical performance of the terminal itself, but, when the contact surface (contact portion) of the terminal is scratched, wears down, or shows the sign of use after the test, it may be difficult to certify as a passed product in the vehicle manufacturing industry where product certification conditions are restrict. Accordingly, there is a need for a check which does not cause a deformation of a terminal and a damage to a contact surface of the terminal.

To this end, a check that contacts by using check equipment provided with a probe formed of a material that has a lower strength than that of a terminal, a check that contacts a side surface of a contact surface of a terminal with a probe, a test that contacts by using check equipment capable of minimizing a force pressed by a probe when the probe contacts, etc. are known, but these tests may result in high costs including equipment replacement costs, etc. and there is still a problem of deformation of connector terminals.

Korean Patent Registration No. 10-1353925 discloses a terminal structure which additionally has a continuity check projection to check continuity separately from a terminal of a connector in order to allow a check pin to perform a check from the outside of the connector without directly contacting a part of the terminal connected with a substrate, and allows a probe to perform a check in direct contact with the continuity check projection. However, the structure disclosed in Korean Patent Registration No. 10-1353925 has a problem that the accuracy of a check is degraded since the check pin does not perform a check on the terminal directly contacting an FPC. In addition, the structure disclosed in Korean Patent Registration No. 10-1353925 has a problem that the continuity check projection of the terminal is exposed to the outside of the connector, excessively increasing the structure of the connector.

### SUMMARY

An object of various embodiments of the present disclosure is to provide a structure which can enhance accuracy of a check on a terminal while reducing a damage to the terminal of a connector by a check pin.

According to an embodiment of the present disclosure, a connector may include: a housing which has an opening formed in one end thereof to receive an FPC, and a plurality of slots formed in the other end thereof to receive terminals; and a plurality of terminals which are coupled to the plurality of slots, respectively, and each of the plurality of terminals may include a contact portion formed at one end thereof to contact the FPC, and a check portion extending and protruding in a direction away from the contact portion.

In an embodiment, the check portion may include a check surface with which a check pin of check device inserted into the opening comes into contact, and the check surface of the check portion may extend along a direction intersecting an insertion direction of the check pin.

In an embodiment, the contact portion may include a contact surface which comes into contact with the FPC, and the check portion may extend from the other side of the contact portion.

In an embodiment, wherein each of the plurality of terminals may further include a fixing portion received in the housing, and the connection portion may connect the contact portion and the check portion to the fixing portion, and the connection portion may be elastically deformable relative to the fixing portion.

In an embodiment, the contact portion may include a first contact portion and a second contact portion which is spaced apart from the first contact portion, the check portion may extend and protrude in a direction away from the first contact portion, each of the plurality of terminals may further include: a fixing portion received in the housing; a first connection portion which connects the first contact portion and the check portion to the fixing portion; and a second connection portion which connects the second contact portion to the fixing portion and is spaced apart from the first connection portion, and the first and second connection portions are elastically deformable relative to the fixing portion, respectively.

In an embodiment, the housing may include a plurality of receiving portions to receive at least one of the plurality of terminals, respectively, each of the plurality of receiving portions may include: a first slit which has at least the same width as one of the plurality of terminals and supports one of the plurality of terminals; and a second slit which is fluidly connected with the first slit and has a width that is wider than a width of the first slit, and wherein the check portion may extend to an inside of the second slit.

In an embodiment, each of the plurality of receiving portions may further include a third slit which is fluidly connected to the second slit and has a width that is narrower than the width of the second slit.

In an embodiment, the check portion may be disposed on substantially the same line as the connection portion and the fixing portion.

A connector assembly according to an embodiment of the present disclosure may include any one connector described above, and a counterpart connector which is coupled to the connector with the FPC.

According to embodiments of the present disclosure, since a probe check is performed through the check portion extending and protruding in the direction away from the contact portion which contacts the FPC, it is possible to check without contacting the contact surface of the terminal, and to prevent the terminal of the connector from being damaged, wearing down, or showing the sign of use by the check pin. In addition, according to embodiments of the present disclosure, since the check is performed through the check portion directly extending from the contact portion of the terminal, the check may be performed without weakening the strength of the probe or minimizing the force pressed on contact, so that the accuracy of the check may be enhanced.

### BRIEF DESCRIPTION OF DRAWINGS

FIG. 1 is a perspective view illustrating a connector according to an embodiment of the present disclosure.

FIG. 2 is a perspective view illustrating the connector according to an embodiment of the present disclosure.

FIG. 3 is an exploded perspective view of the connector according to an embodiment of the present disclosure.

FIG. 4 is a side view illustrating a terminal of the connector according to an embodiment of the present disclosure.

FIG. 5 is an enlarged view of the terminal of the connector according to an embodiment of the present disclosure.

FIG. 6 is a cross-sectional view taken on line A-A′ of FIG. 2 illustrating the connector according to an embodiment of the present disclosure.

FIG. 7 is a view illustrating an example of a state in which a check pin contacts the terminal of the connector according to an embodiment of the present disclosure.

FIG. 8 is a cross-sectional view illustrating an example of a state in which the check pin contacts the terminal of the connector according to an embodiment of the present disclosure.

FIG. 9 is a view illustrating an example of a state in which an FPC is coupled to the connector according to an embodiment of the present disclosure.

FIG. 10 is a cross-sectional cutaway view illustrating an example of the connector of FIG. 9 according to an embodiment of the present disclosure.

### DETAILED DESCRIPTION

Embodiments of the present disclosure are illustrated for the purpose of explaining the technical concept of the present disclosure. The right scope of the present disclosure is not limited to embodiments suggested hereinbelow or detailed descriptions of these embodiments.

All technical terms and scientific terms used in the present disclosure have meanings normally understood by those skilled in the art to which the present disclosure belongs unless otherwise defined. All terms used in the present disclosure are selected for the purpose of explaining the present disclosure more clearly, and are not selected to limit the right scope of the present disclosure.

It should be understood that the terms “comprises”, “includes”, “has”, etc. used in the present disclosure are open-ended terms that have possibility of including other embodiments unless phrases or sentences including corresponding expressions indicate otherwise.

The singular forms used in the present disclosure may include the plural forms as well unless the context clearly indicates otherwise, and this is equally applied to the singular forms described in the claims.

Such terms “first” and “second” used in the present disclosure are used to simply distinguish a plurality of components from one another, and do not limit the components in the aspect of order or importance.

It should be understood that, if an element is referred to as “connected with” or “is coupled with” another element, it means that the element may be directly connected with or coupled with another element or may be connected with or coupled with another element via another new element.

The direction indicating term “upward” used in the disclosure is based on a direction of a connector relative to a check device, and the direction indicating term “downward” refers to the opposite direction of the upward direction. The direction indicating term “vertical direction” used in the present disclosure includes both an upward direction and a downward direction, but should not be understood as meaning one specific direction of the upward direction and the downward direction.

Embodiments will be described hereinbelow with reference to examples illustrated in the accompanying drawings. In the accompanying drawings, the same reference numerals are used for the same or corresponding components. In explaining the following embodiments, a redundant explanation of the same or corresponding components may be omitted. However, even when description of a component is omitted, it is not intended that the component is not included in a certain embodiment.

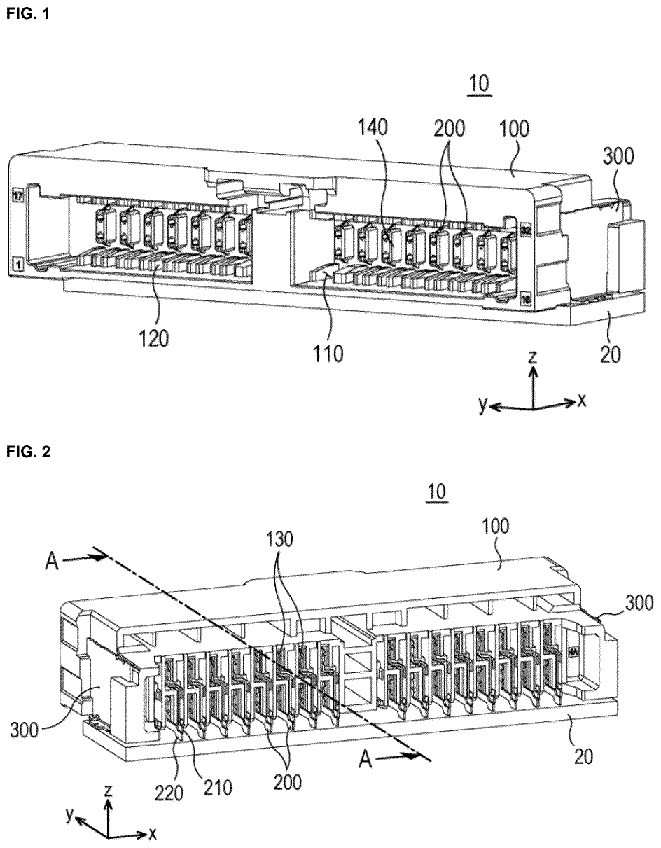

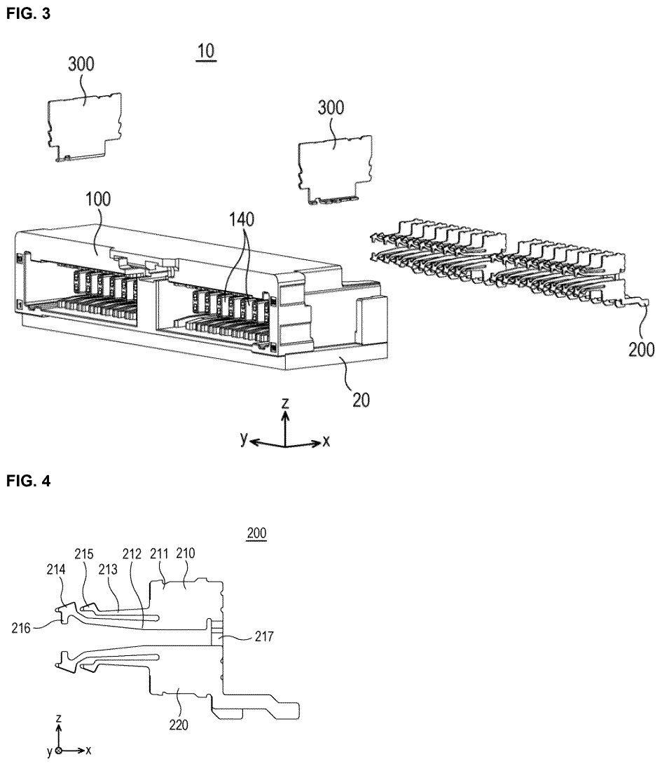

FIG. 1 is a perspective view illustrating a connector according to an embodiment of the present disclosure, FIG. 2 is a perspective view illustrating the connector according to an embodiment of the present disclosure, FIG. 3 is an exploded perspective view of the connector according to an embodiment of the present disclosure, and FIG. 4 is a side view illustrating a terminal of the connector according to an embodiment of the present disclosure.

Referring to FIGS. 1, 2, and 3, a connector 10 according to an embodiment may include a housing 100, a plurality of terminals 200, and a fixing member 300.

The housing 100 may provide (or form) an overall frame of the connector 10. The housing 100 may be coupled with components of the connector 10. For example, the plurality of terminals 200 may be coupled in the housing 100, and the fixing member 300 may be coupled to an outer surface of the housing 100. The housing 100 may be formed by injection molding. In this case, the plurality of terminals 200 may be assembled in the housing 100. In another embodiment, the housing 100 may be formed with the plurality of terminals 200 and the fixing member 300 by injection molding. For example, the connector 10 may be formed by injecting a melt resin for forming the housing 100 into a mold in which the plurality of terminals 200 and the fixing member 300 are disposed and then curing.

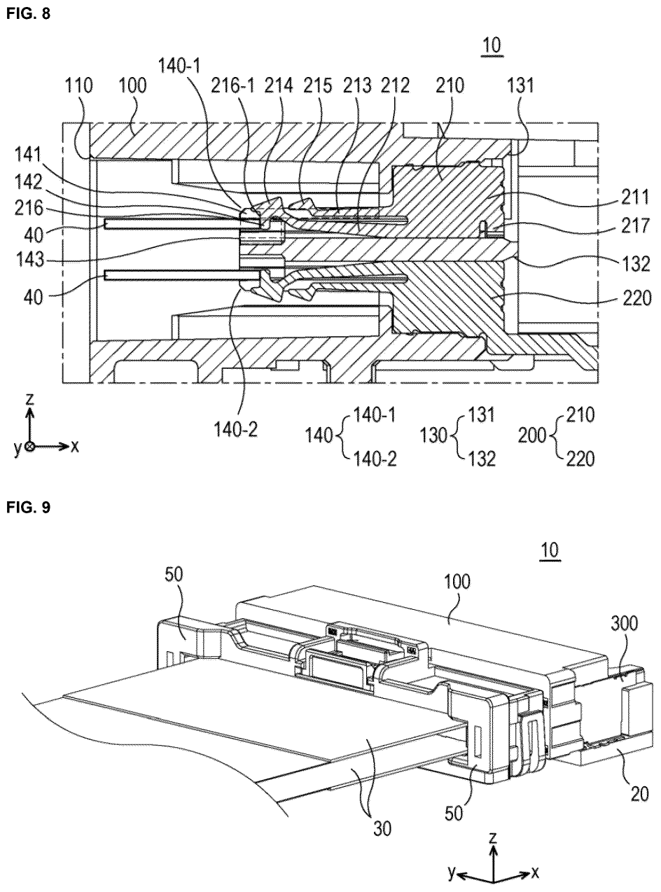

Referring to FIG. 1, one end of the housing 100 may be opened to receive an FPC (for example, an FPC 300 of FIGS. 8 and 9). For example, the housing 100 may include a first opening 110 and a second opening 120. The first opening 110 and the second opening 120 may form spaces to receive the flexible printed circuit (FPC) 30. The first opening 110 and the second opening 120 may be formed by extending from one end of the housing 100 toward the inside of the housing 100.

Referring to FIG. 2, the other end of the housing 100 may be opened to receive the plurality of terminals 200. For example, the housing 100 may include a plurality of slots 130 formed in the other end of the housing 100. The plurality of slots 130 may form spaces into which the plurality of terminals 200 are inserted. The plurality of slots 130 may extend from the other end of the housing 100 toward the first opening 110 and the second opening 120. The number of the plurality of slots 130 may be substantially the same as the number of the plurality of terminals 200, but is not limited thereto.

Referring to FIG. 3, the housing 100 may include a plurality of receiving portions 140 to receive the plurality of terminals 200. Each of the receiving portions 140 may be disposed in the housing 100. For example, the plurality of receiving portions 140 may be disposed between one side of the housing 100 in which the first opening 110 and the second opening 120 are formed, and the other side of the housing 100 in which the plurality of slots 130 are formed. Each of the receiving portions 140 may receive at least a part of at least one terminal 200 in the housing 100. For example, the number of the plurality of receiving portions 140 may correspond to the number of the plurality of terminals 200, but is not limited thereto.

Referring to FIG. 4, the plurality of terminals 200 may be formed of a conductive material (for example, copper) to electrically connect a substrate 20 and the FPC 30. For example, the first terminal 210 and the second terminal 220 may be arranged in the vertical direction (for example, the Z direction), and may be disposed within one receiving portion all together. The first terminal 210 may include a fixing portion 211, a first connection portion 212, a second connection portion 213, a first contact portion 214, a second contact portion 215, and a check portion 216. In an embodiment, the first terminal 210 or the second terminal 220 may not include the second connection portion 213 and the second contact portion 215.

The connector 10 may further include the fixing member 300 to fix the connector 10 to the substrate 20. The fixing member 300 may be coupled onto the substrate 20 with the housing 100, thereby fixing the connector 10 to the substrate 20. The substrate 20 may include a thermosetting resin and a conductive circuit which is stacked on the thermosetting resin. The substrate 20 may be relatively stiff compared to the FPC 30 so as to support components such as the connector 10. For example, the substrate 20 may be a rigid printed circuit board formed of a resin (for example, at least one of FR-4, FR-5, G-2 and G-11).

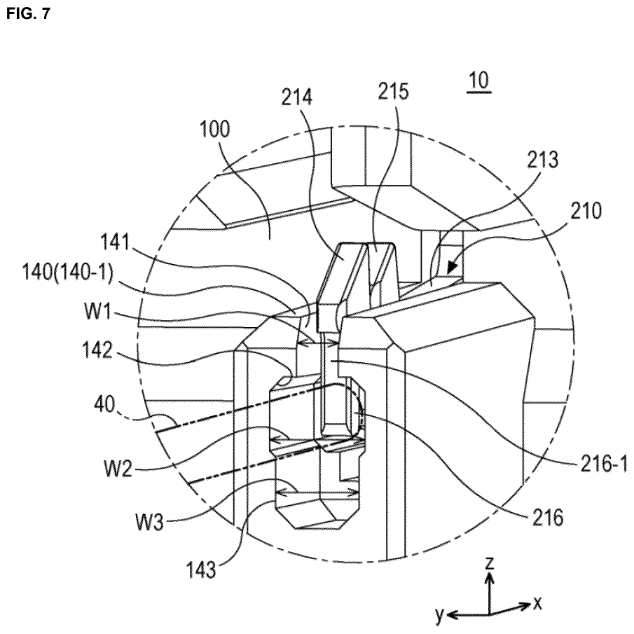

The plurality of terminals 200 may be received in the housing 100, such that the plurality of terminals 200 are not easily visible from the outside of the housing 100. To this end, it is not easy for a check pin (for example, a check pin 40 of FIGS. 7 and 8) for checking the plurality of terminals 200 to approach the terminals in the housing 100 without damaging the plurality of terminals 200. Hereinafter, a structure that can enhance accuracy of a check on the plurality of terminals 200 without damaging the plurality of terminals 200 will be described. Hereinafter, the structure of the connector 20 will be described with reference to the first terminal 210 and the second terminal 220, but this is for the convenience of explanation. Descriptions of the first terminal 210 and the second terminal 220 may be substantially equally applied to at least a part of the plurality of terminals 200.

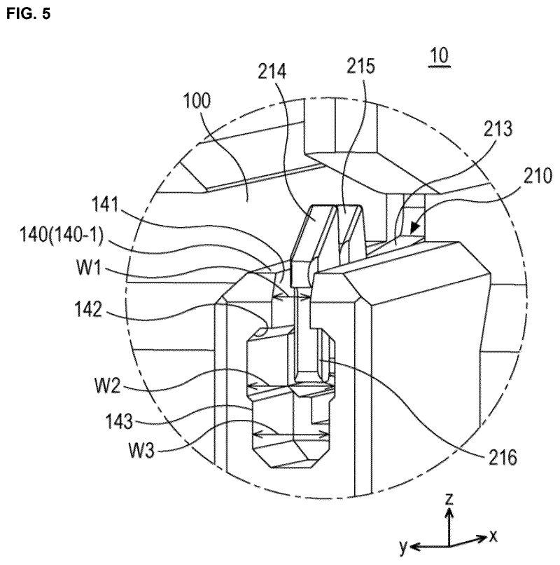

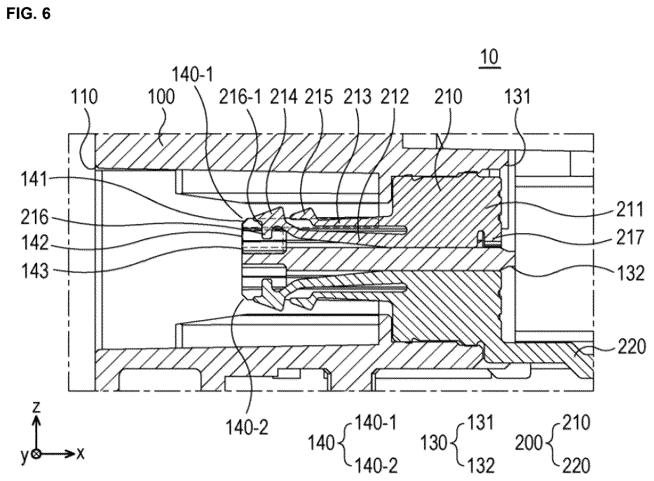

FIG. 5 is an enlarged view of the terminal of the connector according to an embodiment of the present disclosure, and FIG. 6 is a cross-sectional view taken on line A-A′ of FIG. 2 illustrating the connector according to an embodiment of the present disclosure.

Referring to FIGS. 5 and 6, the plurality of slots 130 may include a first slot 131 and a second slot 132. The first slot 131 may receive the first terminal 210. The second slot 132 may receive the second terminal 220. The first slot 131 and the second slot 132 may be arranged (or aligned) along the vertical direction (for example, Z axis direction). As the fixing portion 211 of the first terminal is inserted into the first slot 131, the first connection portion 212, the second connection portion 213, the first contact portion 214, the second contact portion 215, and the check portion 216 may be received in the receiving portion 140.

Referring to FIG. 6, the fixing portion 211 may be disposed on a substrate (for example, the substrate 20 of FIGS. 1 and 2) which supports the connector 10. A thickness of the fixing portion 211 may be thicker than a thickness of the other part of the first terminal 210. Here, a thickness of a component may be expressed by a distance in the vertical direction (for example, the Z-axis direction), and the corresponding expression may be substantially equally utilized in the following descriptions unless mentioned otherwise. A soldering portion 217 of the first terminal 210 may be soldered onto the substrate 20, thereby electrically connecting the first terminal 210 and the substrate 20. The soldering portion 217 may extend from the fixing portion 211 toward the substrate 20. For example, the soldering portion 217 may be bent and extend from the fixing portion 211 toward the substrate 20, thereby having a curved shape to bypass the second terminal 220 A thickness of the soldering portion 217 may be thinner than the thickness of the fixing portion 211.

The first connection portion 212 of the first terminal 210 may connect the first contact portion 214 and the fixing portion 211. For example, the first connection portion 212 may extend from the fixing portion 211 toward one end of the housing 100 in which the first opening 110 is formed, to the first contact portion 214. As an FPC (for example, the FPC 30 of FIGS. 8 and 9) is inserted into the first opening 110, the first connection portion 212 may be elastically deformed relative to the fixing portion 211. For example, when the FPC 30 is inserted, the first connection portion 212 may be elastically deformed upwardly (for example, +Z axis direction) or downwardly (for example, −Z axis direction) relative to the fixing portion 211.

The second connection portion 213 of the first terminal 210 may extend to connect the second contact portion 215 and the fixing portion 211. Like the first connection portion 212, the second connection portion 213 may be elastically deformed upwardly (for example, +Z axis direction) or downwardly (for example, −Z axis direction) by the insertion of the FPC 30.

The first contact portion 214 of the first terminal 210, which directly contacts a part of a conductive circuit of the FPC 30, may be provided at one end of the first connection portion 212 of the first terminal 210. Specifically, when the FPC 30 is inserted into a space between an inner surface of the housing 100 that faces a first receiving portion 140-1, and the first terminal 210, the first contact portion 214 may come into contact with the conductive circuit of the FPC 30, thereby be electrically connected with the conductive circuit of the FPC 30. A thickness of the first contact portion 214 may be thicker than a thickness of the first connection portion 212, but this should not be considered as limiting.

The second contact portion 215 of the first terminal 210, which directly contacts another part of the conductive circuit of the FPC 30, may be provided at one end of the second connection portion 213 of the first terminal 210. Specifically, when the FPC 30 is inserted into the receiving portion 140 of the connector 10, the second contact portion 215 may come into contact with another part of the conductive circuit of the FPC 30, thereby being electrically connected with the conductive circuit of the FPC 30. Since the first contact portion 214 and the second contact portion 215 of the first terminal 210 come into contact with corresponding portions of the conductive circuit of the FPC 30, respectively, dual contact points may be formed between the FPC 30 and the first terminal 210. A thickness of the second contact portion 215 may be thicker than a thickness of the second connection portion 213, but this should not be considered as limiting.

Referring to FIG. 6, the first terminal 210 may include the check portion 216 provided on at least one of the first contact portion 214 and the second contact portion 215. The check pin 40 may be inserted into the first opening 110 to check the plurality of terminals 200, and may come into contact with the check portion 216 of any one of the first contact portion 214 and the second contact portion 215. The check portion 216 may extend and protrude in a direction away from the first contact portion 214. The check portion 216 may extend along a direction intersecting (or perpendicular to) the insertion direction of the check pin 40. For example, the check portion 216 may include a check surface 216-1 with which the check pin 40 comes into contact. The check surface 216-1 of the check portion 216 may have a shape extending along a direction intersecting (or perpendicular to) the insertion direction (for example, the +X axis direction) of the check pin 40. The checking portion 216 may extend and protrude downwardly (for example,-Z axis direction) from the first contact portion 214. The check portion 216 may extend in a direction facing the second terminal 220. The check portion 216 may extend from the other side of the first contact portion 214 that is opposite to the contact surface of the first contact portion 214 which comes into contact with the FPC 30. One side of the first contact portion 214 that corresponds to the contact surface may have a shape slanted (or inclined) relative to the other side of the first contact portion 214, but this should not be considered as limiting. In an embodiment, the check portion 216 may be formed only on the first contact portion 214 that extends closer to the first opening 110 among the first contact portion 214 and the second contact portion 215. The check portion 216 may be formed on the first contact portion 214 which is close to the first opening 110, so that a check is easily performed by the check pin 40. In another embodiment, the check portion 216 may be formed only on the second contact portion 215 among the first contact portion 214 and the second contact portion 215.

Referring to FIG. 5, the first receiving portion 140-1 of the housing 100 may include a first slit 141, a second slit 142, and a third slit 143. Hereinafter, the first slit 141, the second slit 142, and the third slit 143 will be described with reference to the first receiving portion 140-1 with reference to FIGS. 5 and 6, but this is for the convenience of explanation. Descriptions of the first receiving portion 140-1 may be substantially equally applied to all of the plurality of receiving portions 140 (for example, a second receiving portion 140-2).

The first slit 141 may be opened to allow at least one of the first connection portion 212 and the second connection portion 213 of the first terminal 210 to be inserted thereinto. The first slit 141 may have a shape extending along the horizontal direction (for example, the X-axis direction). A part of the first connection portion 212 of the first terminal 210 and a part of the second connection portion 213 may protrude to the outside (for example, upwardly (for example, +Z axis direction)) of the first slit 141. Accordingly, when the FPC 30 is inserted into the first receiving portion 140-1, the first contact portion 214 of the first connection portion 212 and the second contact portion 215 of the second connection portion 213 which protrude and are exposed from the first slit 141 may come into contact with corresponding portions of the FPC 30, respectively. The first slit 141 may have a first width W1. A width of a certain component may indicate a distance in the Y-axis direction, and the corresponding expression will be substantially equally utilized in the following descriptions unless mentioned otherwise. The first width W1 may be set to reduce the movement of the first terminal 210 in a width direction (for example, the Y axis direction) while the FPC 30 is being inserted into the housing 100. For example, the first width W1 may be set to correspond to the width of the first terminal 210, but is not limited thereto.

The first receiving portion 140-1 of the housing 100 may further include the second slit 142 which is fluidly connected to the first slit 141. The second slit 142 may be disposed (formed) on a lower side (for example, −Z axis direction) of the first slit 141. The check portion 216 of the first connection portion 212 may extend to the inside of the second slit 142. The second slit 142 may have a second width W2 that is wider than the first width W1 to receive the check pin 40. For example, the second width W2 may be set to correspond to a width (or a diameter) of the check pin 40. The second slit 142 has the second width W2 wider than the first width W1 of the first slit 141, so that the first slit 141 may support the first terminal 210 on the left and right, and the second slit 142 may provide a space sufficient to allow the check pin 40 to enter the second slit 142 toward the check portion 216 to perform a check.

The first receiving portion 140-1 of the housing 100 may further include the third slit 143 formed on a side facing the first slit 141 to be fluidly connected to the second slit 142. The third slit 143 may be disposed (formed) on a lower side (for example,-Z axis direction) of the second slit 142. The third slit 143 may have a third width W3 that is narrower than the second width W2. For example, the third width W3 may be wider than the first width W1 and may be narrower than the second width W2. Accordingly, the thickness of the housing on a portion (that is, the third slit) of the first receiving portion 140-1 where the check pin does not enter may be made to be thick, so that the housing may be strengthened and the possibility of a damage to the receiving portion 140-1 may be reduced.

An inner structure of the connector 10 may be symmetric with reference to the plurality of receiving portions 140. For example, descriptions of the first terminal 210 and the first receiving portion 140-1 may be substantially equally applied in the following descriptions t to the second terminal 220 and the second receiving portion 140-2.

The plurality of check pins 40 may come into contact with the check portions 216 included in the plurality of terminals 200, respectively, to perform a check on electricity of the plurality of terminals 200. The check performed by the check portion 216 will be described hereinbelow with reference to the drawings.

FIG. 7 is a view illustrating an example of a state in which the check pin contacts the terminal of the connector according to an embodiment of the present disclosure, and FIG. 8 is a cross-sectional view illustrating an example of a state in which the check pin contacts the terminal of the connector according to an embodiment of the present disclosure.

Referring to FIGS. 7 and 8, the check pin 40 may be inserted into the housing 100 through the first opening 110 of the housing 100. The check pin 40 may enter the second slit 142 and may come into contact with the check portion 216 of the first terminal 210. Since the check pin 40 comes into contact with the check portion 216 which is directly connected to the first contact portion 214, the check pin 40 may perform a check on the performance of the first terminal 210 without directly contacting the first contact portion 214 which contacts the FPC 30 (illustrated in FIGS. 8 and 9). In addition, since the check pin 40 does not directly contact the first contact portion 214 of the first terminal 210 which contacts the FPC 30, the first contact portion 214 may be prevented from being damaged, wearing down, and showing the sign of use. A check on the second terminal 220 may be performed after the first terminal 210 is checked, but this should not be considered as limiting. For example, the plurality of terminals 200 may be checked simultaneously by a check device provided with a plurality of check pins 40 corresponding to the number of the plurality of terminals 200.

In an embodiment, referring to FIG. 8, the check portion 216 of the first terminal 210 may be disposed on substantially the same lines in the Y axis and Z axis directions as the first connection portion 212 and the fixing portion 211. Accordingly, even when the check pin 40 presses the check portion 216 of the first terminal 210 in contact therewith during a check, the first connection portion 212 and the fixing portion 211 may support the force and the first terminal may withstand the pressure without being pushed. As a result, an existing probe check device may be used as it is without having to replace with a probe check device having a material of low strength or a check device capable of minimizing pressure of a probe, and also, may prevent a terminal from being damaged, wearing down, and showing the sign of use.

As described above, the connector 10 according to an embodiment may guarantee the contact area of the check pin 40 through the check portion 216 extending and protruding from the first contact portion 214 contacting the FPC 30, so that the possibility of a damage to the plurality of terminals 200 may be reduced and the accuracy of a check may be enhanced.

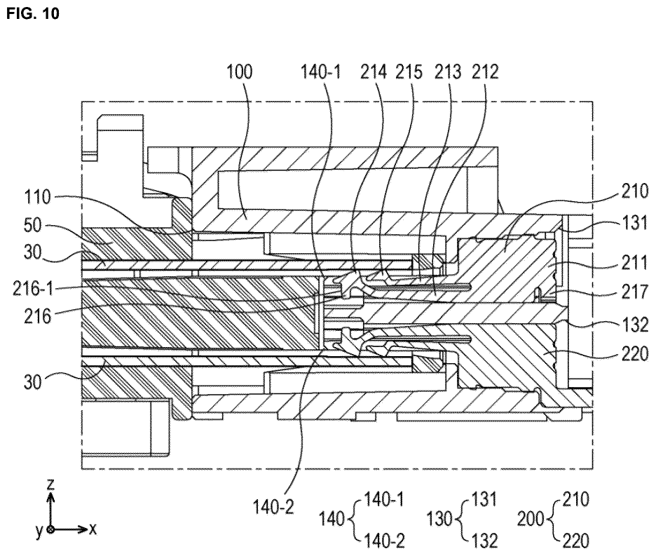

FIG. 9 is a perspective view illustrating an example of a state in which the FPC is coupled to the connector according to an embodiment of the present disclosure, and FIG. 10 is a cross-sectional cutaway view illustrating an example of the connector of FIG. 9 according to an embodiment of the present disclosure.

Referring to FIGS. 9 and 10, when the FPC 30 is coupled with the housing 100 of the connector 10, the FPC 30 may slide to a space between an inner surface of the housing 100 that faces the first receiving portion 140-1, and the first terminal 210. While the FPC 30 is sliding to the space, the first contact portion 214 and the second contact portion 215 may come into contact with the FPC 30, respectively, and the first connection portion 212 and the second connection portion 213 may be elastically deformed in the Z axis direction relative to the fixing portion 211, respectively. The plurality of FPCs 30 may be inserted into the connector 10. As shown in FIG. 10, another FPC 30 may slide to a space between an inner surface of the housing 100 that faces the second receiving portion 140-2, and the second terminal 220, thereby being coupled to the connector 10.

The FPC 30 may be inserted into the connector 10 while being coupled to a counterpart connector 50. For example, the FPC 30 may be inserted into the housing 100 with the counterpart connector 50 while being inserted into the connector 50. The connector 10 and the counterpart connector 50 may be coupled to each other, thereby forming a connector assembly.

Although the technical concept of the present disclosure has been described through some embodiments described above and examples illustrated in the accompanying drawings, it should be noted that various substitutions, modifications, and changes can be made without departing from the technical concept and the scope of the present disclosure that can be understood by those skilled in the art to which the present disclosure belongs. In addition, the substitutions, modification, and changes should be deemed to belong to the claims attached hereto.

1. A connector comprising:
a housing which has an opening formed in one end thereof to receive an FPC, and a plurality of slots formed in the other end thereof to receive terminals; and
a plurality of terminals which are coupled to the plurality of slots, respectively, wherein each of the plurality of terminals comprises a contact portion formed at one end thereof to contact the FPC, and a check portion extending and protruding in a direction away from the contact portion.

2. The connector of claim 1, wherein the check portion comprises a check surface with which a check pin inserted into the opening comes into contact, and the check surface of the check portion extends along a direction intersecting an insertion direction of the check pin.

3. The connector of claim 1, wherein the contact portion comprises a contact surface which comes into contact with the FPC, and wherein the check portion extends from the other side of the contact portion.

4. The connector of claim 1, wherein each of the plurality of terminals further comprises: a fixing portion received in the housing; and a connection portion which connects the contact portion and the check portion to the fixing portion, and wherein the connection portion is elastically deformable relative to the fixing portion.

5. The connector of claim 1, wherein the contact portion comprises a first contact portion and a second contact portion which is spaced apart from the first contact portion, wherein the check portion extends and protrudes in a direction away from the first contact portion, wherein each of the plurality of terminals further comprises:
a fixing portion received in the housing;
a first connection portion which connects the first contact portion and the check portion to the fixing portion; and
a second connection portion which connects the second contact portion to the fixing portion and is spaced apart from the first connection portion, and
wherein the first and second connection portions are elastically deformable relative to the fixing portion, respectively.

6. The connector of claim 1, wherein the housing comprises a plurality of receiving portions to receive at least one of the plurality of terminals, respectively, wherein each of the plurality of receiving portions comprises:
a first slit which has at least the same width as one of the plurality of terminals and supports one of the plurality of terminals; and
a second slit which is fluidly connected with the first slit and has a width that is wider than a width of the first slit, and
wherein the check portion extends to an inside of the second slit.

7. The connector of claim 6, wherein each of the plurality of receiving portions further comprises a third slit which is fluidly connected to the second slit and has a width that is narrower than the width of the second slit.

8. The connector of claim 6, wherein the check portion is disposed on substantially the same line as the connection portion and the fixing portion.

9. A connector assembly comprising:
a connector of claim 1; and
a counterpart connector which is coupled to the connector with the FPC.
